(19) United States
(12) Patent Application Publication
(10) Pub. No.: US 2026/0019350 A1
(43) Pub. Date: Jan. 15, 2026

(54) APPARATUS AND METHOD FOR QOE MEASUREMENT

(71) Applicant: APPLE INC., Cupertino, CA (US)

(72) Inventors: Fangli Xu, Beijing (CN); Haijing Hu, Los Gatos, CA (US); Ralf Rossbach, Munich (DE); Ping-Heng Kuo, London (GB); Naveen Kumar R Palle Venkata, San Diego, CA (US); Peng Cheng, Beijing (CN)

(21) Appl. No.: 18/996,252

(22) PCT Filed: Aug. 5, 2022
(86) PCT No.: PCT/CN2022/110504

§ 371 Date: Jan. 17, 2025

(51) Int. Cl. H04L 41/5067; H04W 24/10; H04W 76/40; H04W 84/04

(52) U.S. Cl. CPC H04L 41/5067; H04W 24/10; H04W 76/40; H04W 84/042

(57) ABSTRACT

The disclosure relates to apparatus and method for quality of user experience (QoE) measurement for services received by a user equipment (UE) in idle/inactive state. In some aspects. the UE device may comprise: at least one antenna: at least one radio. coupled to the at least one antenna and configured to perform wireless communication using at least one radio access technology: and one or more processors coupled to the at least one radio, wherein the one or more processors are configured to cause the UE device to: receive. from a base station (BS). a quality of user experience (QoE) measurement configuration for a service to be received by the UE device in idle or inactive state: perform a QoE measurement for the service received by the UE device in idle or inactive state according to the QoE measurement configuration: generate a QoE measurement report based on the QoE measurement: and transmit the QoE measurement report to the BS.

### TECHNICAL FIELD

This application relates generally to wireless communication systems, including apparatus and method for supporting a quality of user experience (QoE) measurement for services received by a user equipment (UE) device in idle/inactive state.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

UE may perform quality of experience (QoE) measurement for service it receives and report the QoE measurement to the network side. The network side may obtain the QoE measurement report from the UE and report QoE measurement report to a centralized server, for example, Operation Administration and Maintenance (OAM) or QoE server, which may use the QoE measurement report to increase communications quality and device performance in the network. Improvements to QoE measurement and reporting may be beneficial.

### SUMMARY

Some aspects are directed to a user equipment (UE) device. The UE device comprises at least one antenna, at least one radio coupled to the at least one antenna and configured to perform wireless communication using at least one radio access technology, and one or more processors coupled to the at least one radio. The one or more processors are configured to cause the UE device to receive, from a base station (BS), a quality of user experience (QoE) measurement configuration for a service to be received by the UE device in idle or inactive state; perform a QoE measurement for the service received by the UE device in idle or inactive state according to the QoE measurement configuration; generate a QoE measurement report based on the QoE measurement; and transmit the QoE measurement report to the BS.

Other aspects are directed to a base station (BS). The BS comprises at least one antenna, at least one radio coupled to the at least one antenna and configured to perform wireless communication using at least one radio access technology, and one or more processors coupled to the at least one radio. The one or more processors are configured to cause the BS to: transmit, to a user equipment (UE) device, a quality of user experience (QoE) measurement configuration for a service to be received by the UE device in idle or inactive state; and receive, from the UE device, a QoE measurement report for the service.

Still other aspects are directed to a non-transitory computer readable memory medium storing program instructions executable by one or more processors to cause a user equipment (UE) device to: receive, from a base station (BS), a quality of user experience (QoE) measurement configuration for a service to be received by the UE device in idle or inactive state; perform a QoE measurement for the service received by the UE device in idle or inactive state according to the QoE measurement configuration; generate a QoE measurement report based on the QoE measurement; and transmit the QoE measurement report to the BS.

Still other aspects are directed to a non-transitory computer readable memory medium storing program instructions executable by one or more processors to cause a base station (BS) to: transmit, to a user equipment (UE) device, a quality of user experience (QoE) measurement configuration for a service to be received by the UE device in idle or inactive state; and receive, from the UE device, a QoE measurement report for the service.

The techniques described herein may be implemented in and/or used with a number of different types of devices, including but not limited to cellular base stations, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to aspects disclosed herein.

FIG. 2 illustrates a system for performing signaling between a wireless device and a network device, according to aspects disclosed herein.

FIG. 3 is a flowchart diagram illustrating a first example method for QoE measurement and reporting, according to aspects disclosed herein.

FIG. 4 is a flowchart diagram illustrating a second example method for QoE measurement and reporting, according to aspects disclosed herein.

FIG. 5 is a flowchart diagram illustrating a third example method for QoE measurement and reporting, according to aspects disclosed herein.

FIG. 6 is a flowchart diagram illustrating a fourth example method for QoE measurement and reporting, according to aspects disclosed herein.

FIG. 7 is a flowchart diagram illustrating an example method for QoE reporting in connected state, according to aspects disclosed herein.

FIG. 8 is a flowchart diagram illustrating another example method for QoE reporting in connected state, according to aspects disclosed herein.

FIG. 9 is a flowchart diagram illustrating an example method for QoE measurement and reporting, by a UE device, according to aspects disclosed herein.

FIG. 10 is a flowchart diagram illustrating an example method for QoE measurement and reporting, by a BS, according to aspects disclosed herein.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component. Examples of a UE may include a mobile device, a personal digital assistant (PDA), a tablet computer, a laptop computer, a personal computer, an Internet of Things (IoT) device, or a machine type communications (MTC) device, among other examples, which may be implemented in various objects such as appliances, or vehicles, meters, among other examples.

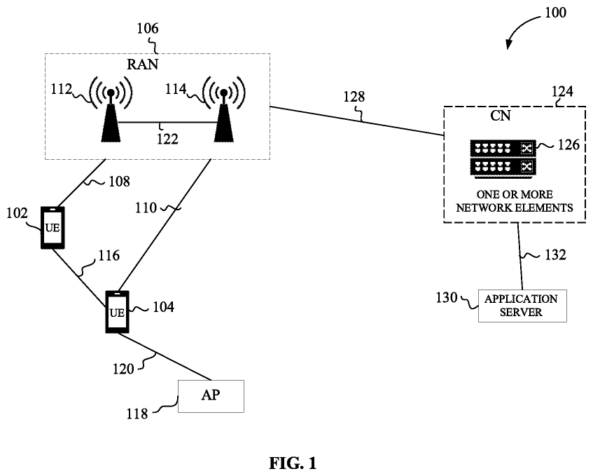

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an SI interface 128. In embodiments, the SI interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VOIP sessions, group communication sessions, etc.) for the UE 102 and UE 104 via the CN 124. The application server 130 may communicate with the CN 124 through an IP communications interface 132.

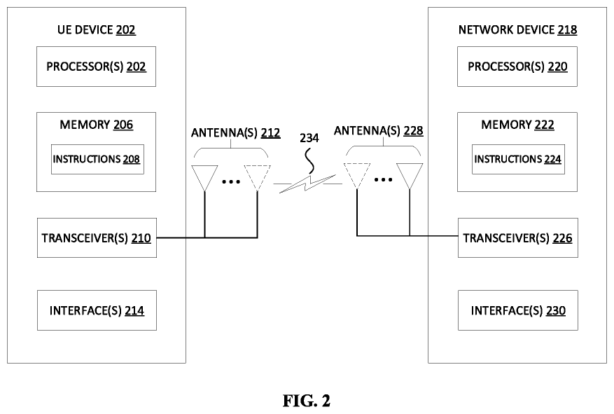

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

UE device, for example UE device 102, 104 or 202 may have a quality of experience (QoE) measurement collection function to perform measurement for service it receives and report the QoE measurement to the serving base station, for example base station 112 or 114. The serving base station may obtain the QoE measurement report from the UE device and report QoE measurement report to a centralized server, for example, Operation Administration and Maintenance (OAM) or QoE server, which may use the QoE measurement report to increase communications quality and device performance in the network. The QoE measurement collection function may collect application layer measurements such as average throughput, initial payout delay, buffer level, etc., for streaming services, i.e., Dynamic Adaptive Streaming over HTTP (DASH), measurements such as corruption duration, Real-time Transport (RTP) packet loss rate, frame rate, jitter duration, etc., for Multimedia Telephony Service for IMS (MTSI) services, and measurements for Virtual Reality (VR) services.

QoE measurement feature may be activated in the next generation RAN (NG-RAN) by one of the two ways, i.e., either by direct configuration from the Operation Administration and Maintenance (OAM system) or by signalling from the OAM via the Core Network, containing UE-associated QoE configuration. The former is so-called management-based activation in which the NG-RAN node selects UE(s) that meet the required QoE measurement capability, area scope and slice scope. The latter is so-called signalling-based activation in which OAM system initiates the QoE measurement activation for a specific UE.

One or more QoE measurement collection jobs can be activated at a UE per service type. Each QoE measurement configuration is uniquely identified by a parameter of QoE Reference. A parameter of measConfigAppLayerId in the RRC signalling is used for identifying the application measurement configuration and report between gNB and UE. The UE may be configured by the gNB to report when a QoE measurement session starts or stops for an application measurement configuration.

QoE configuration deactivation may permanently stop all or some of QoE measurement collection jobs towards a UE, resulting in the release of the corresponding QoE configuration in UE.

In a RAN overload situation, QoE measurement collection pause/resume procedure may be used to pause/resume the reporting for all QoE reports or to pause/resume QoE reporting per QoE configuration in a UE. When the UE receives the QoE pause indication, UE temporarily stores application layer measurement reports in access stratum (AS) layer. When the UE receives the QoE resume indication, UE sends the stored application layer measurement reports to the gNB.

Currently, the QoE measurement configuration and reporting are only supported in RRC CONNECTED state. Operators can only acquire the QoE information for the service which is provided to the UE in CONNECTED state, but cannot acquire the QOE information for the service provided for the UE in IDLE/INACTIVE state, e.g. broadcast or multicast service (MBS). The configuration and reporting technique for supporting the QoE measurement for the service provided to UEs in IDLE/INACTIVE state may beneficial.

Various embodiments relating to QoE measurement configuration and reporting for the services to be received by UEs in IDLE/INACTIVE state are provided hereafter. For simplification, MBS service is illustrated as an example for such services. Those skilled in the art would understand that this is not limiting, and the aspects depicted here could be applied to other services to be received by UEs in IDLE/INACTIVE state.

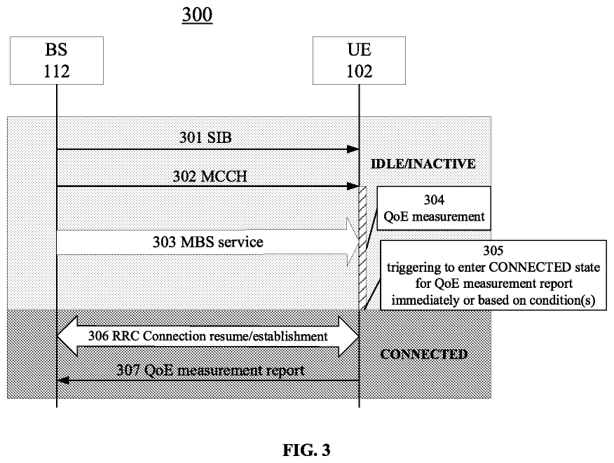

FIG. 3 is a flowchart diagram illustrating a first example method for QoE measurement and reporting, according to aspects disclosed herein. The diagram 300 is described with regard to the BS 112 and UE 102 of FIG. 1 with the arrangements of FIG. 2. Those skilled in the art would understand that the procedure of the diagram 300 may be applied to the BS 114 and UE 104 of FIG. 1.

The signaling diagram 300 relates to a scenario in which the network side including BS provides QoE measurement configuration related to the services received by the UE device in IDLE/INACTIVE state by broadcast, and UE triggers to enter the CONNECTED state to transmit the QoE measurement report immediately or based on some condition(s).

In 301, BS 112 transmits a system information block (SIB) to UE 102. The SIB may carry the QoE measurement configuration for a service to be received by the UE device in idle or inactive state, e.g., MBS. According to one aspect, the SIB may be SIB20 or SIB21 which was defined previously but now comprises a newly defined QoE measurement configuration related to the MBS. According to another aspect, the SIB may be a newly defined one which is dedicated to providing the QoE measurement configuration related to the MBS.

The QoE measurement configuration carried by SIB may indicate a specific MBS service for which the UE device performs the QoE measurement by specifying a temporary mobile group identity (TMGI). Additionally or alternatively, the QoE measurement configuration may indicate a list of one or more public land mobile networks (PLMNs) or a list of one or more frequencies for which the UE device performs the QoE measurement for the MBS service.

According to yet another aspect, the QoE measurement configuration related to the MBS may be not carried in the SIB, but in the MultiCast Control Channel (MCCH) as depicted in 302, together with an MBS session configuration related to the MBS.

In 302, the BS 112 transmits a MCCH message to UE 102. The MCCH is used to provide the MBS session configuration related to the MBS. As discussed above, the MCCH may also carry the QoE measurement configuration related to the MBS.

The QoE measurement configuration carried in MCCH may indicate a specific MBS service for which the UE device performs the QoE measurement, for example, by specifying an MBS protocol data unit (PDU) session ID or a TMGI. Additionally or alternatively, the QoE measurement configuration may indicate a list of one or more PLMNs or a list of one or more frequencies for which the UE device performs the QoE measurement for the MBS service.

In 303, the BS 112 provides the MBS service to the UE 102.

In 304, the UE 102 performs a QoE measurement for the service received by the UE 102 in idle or inactive state according to the QoE measurement configuration.

According to one aspect, the UE 102 may perform the QoE measurement when the indicated service is activated for transmission, e.g., by paging.

Additionally or alternatively, the UE 102 may perform the QoE measurement when the indicated service meets at least one of one or more conditions. The conditions may comprise at least the UE device 102 supports and is interested in the service and has a capability to perform the QoE measurement in the idle or inactive state.

Additionally, the conditions may comprise at least one of the following: 1) the service is provided on a cell where the UE device is camping; 2) the service belongs to a same operator as the cell where the UE device is camping; 3) the service belongs to a list of one or more PLMNs, equivalent PLMNs (EPLMNs) or visited PLMNs (VPLMNs) the UE device has; or 4) the service belongs to a list of one or more operators or PLMNs indicated in the QoE measurement configuration.

An an example, in a case that the UE 102 in IDLE/INACTIVE state camps on Cell 1 at frequency F1, and receives the MBS service X on Cell 2 at frequency F2, the UE 102 does not need to perform the QoE measurement for the MBS service X.

As another example, in a case that the UE 102 in IDLE/INACTIVE state camps on Cell 1 at frequency F1 belonging to PLMN A, and receives the MBS service X provided by PLMN B, the UE 102 does not need to perform the QoE measurement for the MBS service X.

As yet another example, in a case that the UE 102 in IDLE/INACTIVE state is not interested in the MBS service X which is configured for QoE measurement, the UE 102 does not need to perform the QoE measurement for the MBS service X.

The UE 102 may generate a QoE measurement report based on the QoE measurement. According to one aspect, the UE 102 may log the QoE measurement for the service belonging to same operators. Additionally or alternatively, the UE 102 may log location information and timestamp associated with the QoE measurement. The location information may be a cell ID or frequency ID, or the Global Navigation Satellite System (GNSS) location.

The UE device 102 may stop the QoE measurement upon determining that at least one of one or more conditions is met. The conditions may comprise a buffer for logging the QoE measurement report overflows, or a period for performing the QoE measurement exceeds a threshold.

In 305, the UE 102 may trigger to enter into a CONNECTED state immediately when the QoE measurement report is ready, according to one aspect.

According to another aspect, in 305, the UE 102 may trigger to enter into a CONNECTED state based on determination that at least one of one or more conditions is met. The conditions may comprise an amount of the logged QoE measurement reports exceeds a threshold or the buffer for logging the QoE measurement report(s) overflows or a used size of the buffer exceeds a threshold, etc.

In 306, upon the triggering, the UE 102 may establish a RRC connection with the BS 112 via the RRC connection resume/establishment procedure to enter into the CONNECTED state.

In 307, the UE 102 may transmit the QoE measurement report to the BS 112 upon entering into the CONNECTED state.

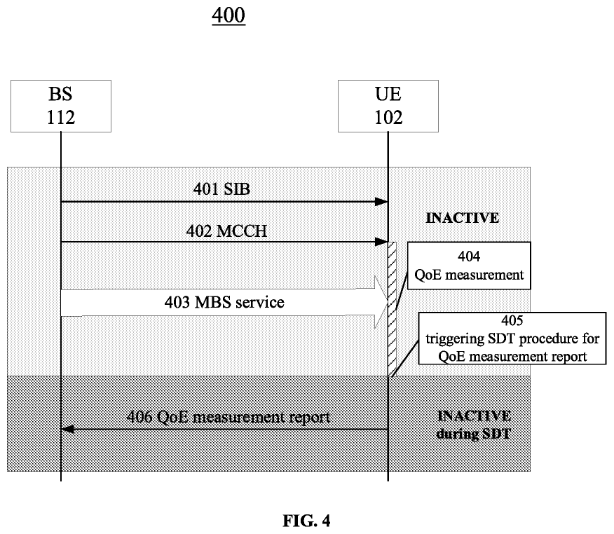

FIG. 4 is a flowchart diagram illustrating a second example method for QoE measurement and reporting, according to aspects disclosed herein. The diagram 400 is described with regard to the BS 112 and UE 102 of FIG. 1 with the arrangements of FIG. 2. Those skilled in the art would understand that the procedure of the diagram 400 may be applied to the BS 114 and UE 104 of FIG. 1.

The signaling diagram 400 relates to a scenario in which the network side including BS provides QoE measurement configuration related to the services received by the UE device in INACTIVE state by broadcast, and UE triggers to enter a small data transmission (SDT) state immediately to transmit the QoE measurement report. SDT feature in RRC INACTIVE state may enable a UE in RRC INACTIVE state to transmit infrequent and small data without requiring an RRC state transition.

The operations 401, 402, 403 and 404 of FIG. 4 may be same as or similar to operations 301, 302, 303 and 304 of FIG. 3. Thus, the above discussion in connection with 301, 302, 303 and 304 can be applied to 401, 402, 403 and 404, except that the operations in FIG. 4 occur only in the RRC INACTIVE state. The detailed discussion for 401, 402, 403 and 404 is omitted for simplification.

In 405, the UE 102 may trigger a SDT procedure immediately when the QoE measurement report is ready. In this case, the network side should have configured the UE device previously to enable the SDT to be triggered by QoE report.

In 406, upon the triggering, the UE 102 may transmit the QoE measurement report to the BS 112 via the SDT procedure.

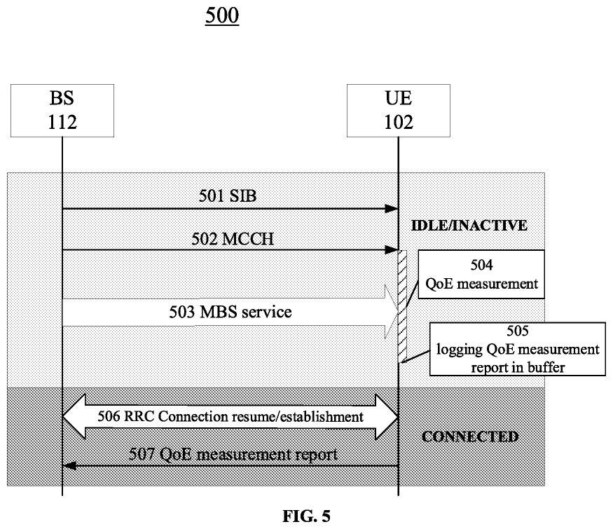

FIG. 5 is a flowchart diagram illustrating a third example method for QoE measurement and reporting, according to aspects disclosed herein. The diagram 500 is described with regard to the BS 112 and UE 102 of FIG. 1 with the arrangements of FIG. 2. Those skilled in the art would understand that the procedure of the diagram 500 may be applied to the BS 114 and UE 104 of FIG. 1.

The signaling diagram 500 relates to a scenario in which the network side including BS provides QoE measurement configuration related to the services received by the UE device in IDLE/INACTIVE state by broadcast, and UE logs the QoE measurement report in a buffer and transmit the QoE measurement report when UE enters the CONNECTED state at a later time.

The operations 501, 502, 503 and 504 of FIG. 5 may be same as or similar to operations 301, 302, 303 and 304 of FIG. 3. Thus, the above discussion in connection with 301, 302, 303 and 304 can be applied to 501, 502, 503 and 504, for which the detailed discussion is omitted for simplification.

In 505, the UE 102 may log the QoE measurement report in a buffer to hold off the transmission, instead of triggering to enter the CONNECTED state or SDT to transmit it, when the QoE measurement report is ready.

When the UE 102 is triggered to enter the CONNECTED state by other reason(s), instead of the QoE measurement report, at a later time, the UE 102 may establish a RRC connection with the BS 112 via the RRC connection resume/establishment procedure to enter into the CONNECTED state, in 506.

In 507, the UE 102 may transmit the QoE measurement report to the BS 112 upon entering into the CONNECTED state.

Although FIG. 5 shows an embodiment in which the UE 102 is triggered to enter the CONNECTED state by other reason(s), those skilled in the art would understand that the UE 102 may be triggered to enter the SDT state by other reason(s) to transmit the QoE measurement report.

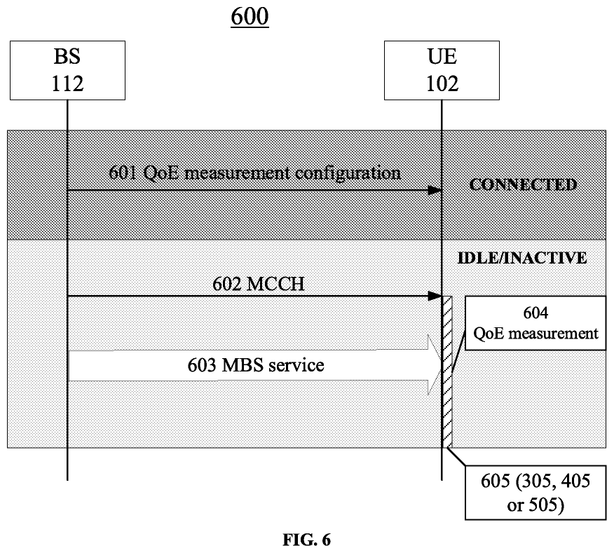

FIG. 6 is a flowchart diagram illustrating a fourth example method for QoE measurement and reporting, according to aspects disclosed herein. The diagram 600 is described with regard to the BS 112 and UE 102 of FIG. 1 with the arrangements of FIG. 2. Those skilled in the art would understand that the procedure of the diagram 500 may be applied to the BS 114 and UE 104 of FIG. 1.

The signaling diagram 600 relates to a scenario in which the network side including BS provides the QoE measurement configuration related to the services received by the UE device in IDLE/INACTIVE state via a signaling dedicated to the UE device in CONNECTED state.

In 601, the BS 112 transmits the QoE measurement configuration related to the MBS service via a signaling dedicated to the UE device when the UE device is in CONNECTED state. The configuration can be applied when the UE is in any RRC state.

The UE device may transit from the CONNECTED state to the IDLE/INACTIVE state at a later time. During the IDLE/INACTIVE state, the UE device may receive an MBS service. In such case, the UE 102 may receive an MCCH message in 602 and receive a corresponding MBS service in 603.

In 604, the UE 102 may perform the QoE measurement for the MBS service according to the QoE measurement configuration received in CONNECTED state previously.

The operations 602, 603 and 604 of FIG. 6 may be same as or similar to operations 302, 303 and 304 of FIG. 3. Thus, the above discussion in connection with 302, 303 and 304 can be applied to 602, 603 and 604, for which the detailed discussion is omitted for simplification.

The QoE measurement reporting mechanism 605 after the QoE measurement 604 can be same as or similar to 305 of FIG. 3, 405 of FIG. 4, or 505 of FIG. 5. In other words, UE 102 may trigger to enter CONNECTED state immediately or based on some conditions to transmit the QoE measurement report, or trigger a SDT procedure immediately to transmit the QoE measurement report, or log the QoE report in the buffer and then transmit the QoE measurement report when entering the CONNECTED state or SDT state due to other reason(s).

Although FIG. 6 shows an example in which the UE device performs the QoE measurement at some time point in the IDLE/INACTIVE state, it may be possible for the UE device to perform the QoE measurement in the CONNECTED state and keep on the QoE measurement when the UE device transits from the CONNECTED state to the IDLE/INACTIVE state.

Although FIG. 6 shows an example in which the UE device 102 receives the QoE measurement configuration via a dedicated signaling when the UE device is in CONNECTED state at 601, it may be possible for the UE device 102 to receive the QoE measurement configuration via a dedicated signaling in a SDT period in the inactive state at 601.

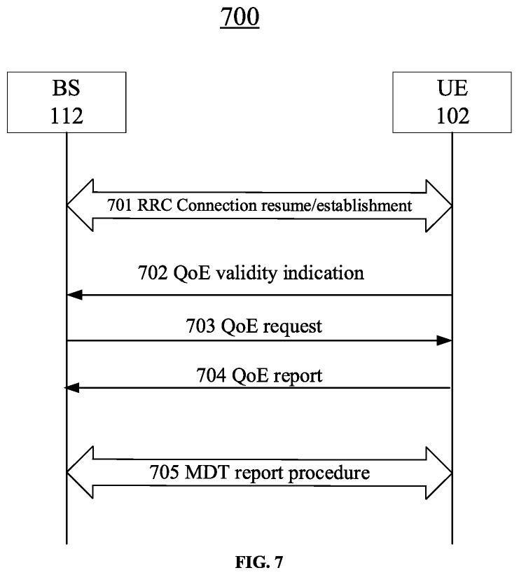

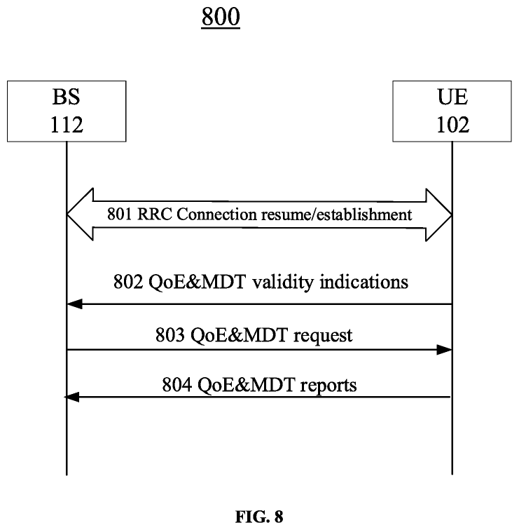

FIGS. 7 and 8 illustrate embodiments for QoE measurement reporting in CONNECTED state, according to aspects disclosed herein. The QoE measurement report can be reported separately from or together with a Minimization of Drive Test (MDT) report.

MDT is a mechanism designed to enable operators to use UE devices in a network to collect mobile network data. One of the MDT functionalities is logged MDT, in which the MDT occurs when the UE is in IDLE state, and the MDT measurements are logged and reported at a later time.

FIG. 7 is a flowchart diagram illustrating a method of reporting QoE measurement separately from the logged MDT report.

Upon UE device 102 requesting to enter CONNECTED state at 305, 505, or 605, at 701, the UE 102 may establish a RRC connection with the BS 112 to enter into the CONNECTED state.

At 702, the UE 102 may transmit, to the BS 112, a QoE measurement report validity indication via a first RRC message, e.g., RRCSetupComplete or RRCResumeComplete message.

At 703, the BS 112 transmit, to the UE 102, a second RRC message, e.g., UEInformationRequest, for requesting the QoE measurement report.

At 704, the UE 102 may transmit, to the BS 112, the QoE measurement report via a third RRC message, e.g., UEInformationRequest.

At 705, the UE 102 may initiate a separate MDT reporting procedure to report the MDT to the BS 112.

FIG. 8 is a flowchart diagram illustrating a method of reporting QoE measurement together with the logged MDT report.

Upon UE device 102 requesting to enter CONNECTED state at 305, 505, or 605, at 801, the UE 102 may establish a RRC connection with the BS 112 to enter into the CONNECTED state.

At 802, the UE 102 may transmit, to the BS 112, a QoE&MDT measurement report validity indication via a first RRC message, e.g., RRCSetupComplete or RRCResumeComplete message.

At 803, the BS 112 transmit, to the UE 102, a second RRC message, e.g., UEInformationRequest, for requesting the QoE&MDT measurement report.

At 804, the UE 102 may transmit, to the BS 112, the QoE&MDT measurement report via a third RRC message, e.g., UEInformationRequest.

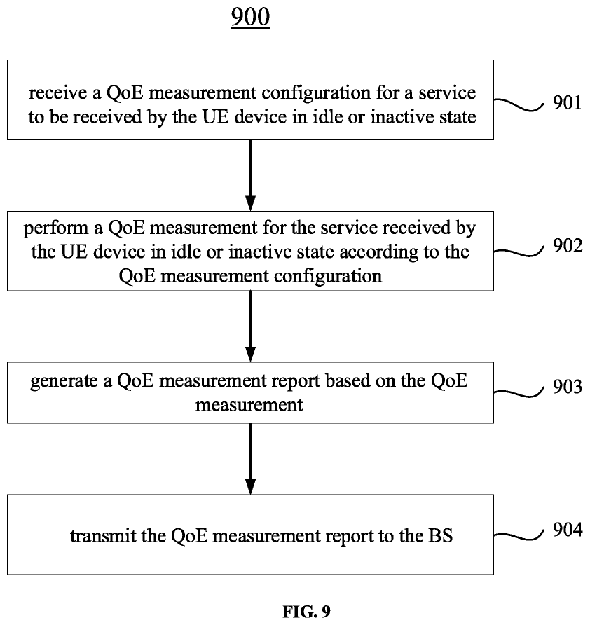

FIG. 9 is a flowchart diagram illustrating an example method 900 for QoE measurement and reporting according to aspects disclosed herein. The method 900 relates to operations performed on the UE device 102 side.

At 901, the UE device 102 receives, from the BS 112, a QoE measurement configuration for a service to be received by the UE device in idle or inactive state.

In one aspect, the service is an MBS service, and the QoE measurement configuration may be received by broadcast via one of 1) being provided in an SIB related to the MBS; 2) being provided together with an MBS session configuration related to the MBS; or 3) being provided in a SIB dedicated to the QoE measurement configuration related to the MBS.

In another aspect, the QoE measurement configuration may be received via a signaling dedicated to the UE device when the UE device is in connected state or in a small data transmission (SDT) period in the inactive state, and the QoE measurement configuration is applicable to the UE device when the UE device is in connected state, idle state or inactive state.

The QoE measurement configuration may indicate a specific MBS service, for example, by specifying an MBS protocol data unit (PDU) session ID or a temporary mobile group identity (TMGI).

Additionally or alternatively, the QoE measurement configuration may indicate a list of one or more public land mobile networks (PLMNs) or a list of one or more frequencies for which the UE device performs the QoE measurement for the MBS.

At 902, the UE device 102 performs a QoE measurement for the service received by the UE device in idle or inactive state according to the QoE measurement configuration.

In one aspect, the UE device 102 may perform the QoE measurement when the service is activated for transmission.

Additionally or alternatively, the UE device 102 may perform the QoE measurement upon determination that the UE device supports and is interested in the service and has a capability to perform the QoE measurement in the idle or inactive state.

Additionally or alternatively, the UE device 102 may perform the QoE measurement when the service meets at least one of the following conditions: 1) the service is provided on a cell where the UE device is camping; 2) the service belongs to a same operator as a cell where the UE device is camping; 3) the service belongs to a list of one or more public land mobile networks (PLMNs), equivalent PLMNs (EPLMNs) or visited PLMNs (VPLMNs) the UE device has; or 4) the service belongs to a list of one or more operators or PLMNs indicated in the QoE measurement configuration.

In another aspect, if the QoE measurement configuration is received via a signaling dedicated to the UE device when the UE device is in connected state or in a small data transmission (SDT) period in the inactive state, the UE device may keep on the QoE measurement when the UE device transits from the connected state to the idle or inactive state.

The UE device 102 may stop the QoE measurement upon determining that at least one of the following conditions is met: 1) a buffer for logging the QoE measurement report overflows, or 2) a period for performing the QoE measurement exceeds a threshold.

At 903, the UE device 102 generates a QoE measurement report based on the QoE measurement.

In one aspect, the UE device 102 may log the QoE measurement for the service belonging to same operators.

Additionally or alternatively, the UE device 102 may log location information and timestamp associated with the QoE measurement. The location information and the timestamp can be used by the network side to associate the QoE report and logged MDT, and acquire the MBS service related radio quality information based on the association for further optimization.

At 904, the UE device 102 transmits the QoE measurement report to the BS 112.

According to a first aspect, the UE device 102 in the idle or inactive state may trigger to enter a connected state upon the QoE measurement report being ready, establish a RRC connection with the BS to enter a connected state, and transmit the QoE measurement report to the BS when the UE device enters the connected state.

According to a second aspect, the UE device 102 in the idle or inactive state may log one or more QoE measurement reports in a buffer upon the QoE measurement reports being ready, determine whether at least one of some conditions is met, trigger to enter a connected state upon determining the at least one condition is met, establish a RRC connection with the BS to enter a connected state, and transmit the one or more QoE measurement reports to the BS when the UE device enters the connected state. The conditions may comprise an amount of the QoE measurement reports exceeds a threshold, or the buffer overflows or a used size of the buffer exceeds a threshold, etc.

According to a third aspect, the UE device 102 in inactive state may trigger a small data transmission (SDT) procedure upon the QoE measurement report being ready, and transmit the QoE measurement report to the BS in the inactive state via the SDT procedure.

According to a fourth aspect, the UE device 102 in the idle or inactive state may log the QoE measurement report in a buffer upon the QoE measurement report being ready, and transmit the QoE measurement report to the BS when the UE device enters a connected state or a small data transmission (SDT) state subsequently.

As for the QoE measurement reporting in CONNECTED state, the QoE measurement report can be reported separately from or together with a Minimization of Drive Test (MDT) report. In the former scenario, the UE device 102 may transmit a QoE measurement report validity indication via a first RRC message upon entering the connected state to the BS, receive a second RRC message for requesting the QoE measurement report from the BS, and transmit the QoE measurement report via a third RRC message to the BS. In the latter scenario, the UE device 102 may comprise a minimization of drive test (MDT) report validity indication together with the QoE measurement report validity indication in the first RRC message, the BS 112 may request an MDT measurement report together with the QoE measurement report in the second RRC message, and the UE device 102 may carry the MDT measurement report together with the QoE measurement report in the third RRC message.

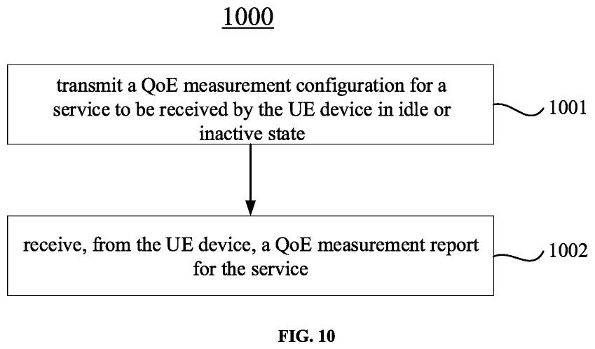

FIG. 10 is a flowchart diagram illustrating an example method 1000 for QoE measurement and reporting according to aspects disclosed herein. The method 1000 relates to operations performed on the BS 112 side.

At 1001, the BS 112 transmits, to a UE device, a QoE measurement configuration for a service to be received by the UE device in idle or inactive state.

In one aspect, the service is an MBS service, and the QoE measurement configuration may be provided by broadcast via one of 1) being provided in an SIB related to the MBS; 2) being provided together with an MBS session configuration related to the MBS; or 3) being provided in a SIB dedicated to the QoE measurement configuration related to the MBS.

In another aspect, the QoE measurement configuration may be provided via a signaling dedicated to the UE device when the UE device is in connected state or in a small data transmission (SDT) period in the inactive state, and the QoE measurement configuration is applicable to the UE device when the UE device is in connected state, idle state or inactive state.

The QoE measurement configuration may indicate a specific MBS service, for example, by specifying an MBS protocol data unit (PDU) session ID or a temporary mobile group identity (TMGI).

Additionally or alternatively, the QoE measurement configuration may indicate a list of one or more public land mobile networks (PLMNs) or a list of one or more frequencies for which the UE device performs the QoE measurement for the MBS.

At 1001, the BS 112 receives, from the UE device, a QoE measurement report for the service.

According to one aspect, the BS 112 may receive the QoE measurement report via RRC signaling from the UE 102 in a CONNECTED state. The QoE measurement report can be reported separately from or together with a Minimization of Drive Test (MDT) report. In the former scenario, the BS 112 may receive a QoE measurement report validity indication via a first RRC message from the UE device, transmit a second RRC message for requesting the QoE measurement report to the UE device, and receive the QoE measurement report via a third RRC message from the UE device. In the latter scenario, the UE device 102 may comprise a minimization of drive test (MDT) report validity indication together with the QoE measurement report validity indication in the first RRC message, the BS 112 may request an MDT measurement report together with the QoE measurement report in the second RRC message, and the UE device 102 may carry the MDT measurement report together with the QoE measurement report in the third RRC message.

According to another aspect, the BS 112 may receive the QoE measurement report via a small data transmission (SDT) procedure upon the UE device' request.

Embodiments contemplated herein include an apparatus comprising means to perform one or more elements of one or more methods as discussed above. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of one or more methods as above. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of one or more methods as above. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of one or more methods as above. This apparatus may be, for example, an apparatus of a UE (such as a wireless device 202 that is a UE, as described herein).

Embodiments contemplated herein include a signal as described in or related to one or more elements of the one or more methods as above.

Embodiments contemplated herein include a computer program or computer program product comprising instructions, wherein execution of the program by a processor is to cause the processor to carry out one or more elements of one or more methods as above. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of one or more methods as above. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of one or more methods as above. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of one or more methods as above. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of one or more methods as above. This apparatus may be, for example, an apparatus of a base station (such as a network device 218 that is a base station, as described herein).

Embodiments contemplated herein include a signal as described in or related to one or more elements of one or more methods as above.

Embodiments contemplated herein include a computer program or computer program product comprising instructions, wherein execution of the program by a processing element is to cause the processing element to carry out one or more elements of one or more methods as above. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE) device, comprising:
at least one antenna:
at least one radio, coupled to the at least one antenna and configured to perform wireless communication using at least one radio access technology: and
one or more processors coupled to the at least one radio, wherein the one or more processors are configured to cause the UE device to:
receive, from a base station (BS), a quality of user experience (QoE) measurement configuration for a service to be received by the UE device in an idle state or an inactive state:
perform a QoE measurement for the service received by the UE device in the idle state or the inactive state according to the QoE measurement configuration:
generate a QoE measurement report based on the QoE measurement: and
transmit the QoE measurement report to the BS.

2. The UE device according to claim 1, wherein the service is a multicast and broadcast service (MBS), and the QoE measurement configuration is received by broadcast via one of the following:
being provided in a system information block (SIB) related to the MBS:
being provided together with an MBS session configuration related to the MBS; or
being provided in a SIB dedicated to the QoE measurement configuration related to the MBS.

3. The UE device according to claim 1, wherein the QoE measurement configuration is received via a signaling dedicated to the UE device when the UE device is in a connected state or in a small data transmission (SDT) period in the inactive state, and the QoE measurement configuration is applicable to the UE device when the UE device is in the connected state, the idle state or the inactive state.

4. The UE device according to claim 3, wherein the one or more processors are further configured to cause the UE device to keep on the QoE measurement when the UE device transits from the connected state to the idle state or the inactive state.

5. The UE device according to claim 1, wherein the service is a multicast and broadcast service (MBS), and the QoE measurement configuration indicates a specific MBS service.

6. The UE device according to claim 1, wherein the service is a multicast and broadcast service (MBS), and the QoE measurement configuration indicates a list of one or more public land mobile networks (PLMNs) or a list of one or more frequencies for which the UE device performs the QoE measurement for the MBS.

7. The UE device according to claim 1, wherein performing the QoE measurement comprises performing the QoE measurement when the service is activated for transmission.

8. The UE device according to claim 7, wherein performing the QoE measurement further comprises performing the QoE measurement upon determination that the UE device supports and is interested in the service and has a capability to perform the QoE measurement in the idle state or the inactive state.

9. The UE device according to claim 8, wherein performing the QoE measurement further comprises performing the QoE measurement when the service meets at least one condition selected from a group comprising:
the service is provided on a cell where the UE device is camping:
the service belongs to a same operator as the cell where the UE device is camping:
the service belongs to a list of one or more public land mobile networks (PLMNs), equivalent PLMNs (EPLMNs) or visited PLMNs (VPLMNs) the UE device has: and
the service belongs to a list of one or more operators or PLMNs indicated in the QoE measurement configuration.

10. The UE device according to claim 1, wherein generating the QoE measurement report comprises logging the QoE measurement for the service belonging to same operators.

11. The UE device according to claim 1, wherein generating the QoE measurement report comprises logging location information and timestamp associated with the QoE measurement.

12. The UE device according to claim 1, wherein transmitting the QoE measurement report comprises:
triggering to enter a connected state by the UE device in the idle state or the inactive state upon the QoE measurement report being ready:
establishing a RRC connection with the BS to enter the connected state; and
transmitting the QoE measurement report to the BS by the UE device when the UE device enters the connected state.

13. The UE device according to claim 1, wherein transmitting the QoE measurement report comprises:
logging one or more QoE measurement reports in a buffer by the UE device in the idle state or the inactive state upon the QoE measurement reports being ready:
determining whether at least one condition is met from a group comprising:
an amount of the QoE measurement reports exceeds a first threshold, or
the buffer overflows or a used size of the buffer exceeds a second threshold:
triggering to enter a connected state by the UE device in the idle state or the inactive state upon determining the at least one condition is met:
establishing a RRC connection with the BS to enter the connected state; and
transmitting the one or more QoE measurement reports to the BS by the UE device when the UE device enters the connected state.

14. The UE device according to claim 1, wherein transmitting the QoE measurement report comprises:
triggering a small data transmission (SDT) procedure by the UE device in the inactive state upon the QoE measurement report being ready: and
transmitting the QoE measurement report to the BS by the UE device in the inactive state via the SDT procedure.

15. The UE device according to claim 1, wherein transmitting the QoE measurement report comprises:
logging the QoE measurement report in a buffer by the UE device in the idle state or the inactive state upon the QoE measurement report being ready: and
transmitting the QoE measurement report to the BS when the UE device enters a connected state or a small data transmission (SDT) state subsequently.

16. The UE device according to claim 15, wherein transmitting the QoE measurement report to the BS by the UE device when the UE device enters the connected state comprises:
transmitting, to the BS, a QoE measurement report validity indication via a first RRC message upon entering the connected state:
receiving, from the BS, a second RRC message for requesting the QoE measurement report: and
transmitting, to the BS, the QoE measurement report via a third RRC message.

17. The UE device according to claim 16, wherein:
the first RRC message further comprises a minimization of drive test (MDT) report validity indication,
the second RRC message further requests an MDT measurement report together with the QoE measurement report, and
the third RRC message carries the MDT measurement report together with the QoE measurement report.

18. The UE device according to claim 1, wherein the one or more processors are further configured to cause the UE device to stop the QoE measurement upon determining that at least one of the following conditions is met:
a buffer for logging the QoE measurement report overflows, or
a period for performing the QoE measurement exceeds a threshold.

19. A base station (BS), comprising:
at least one antenna:
at least one radio, coupled to the at least one antenna and configured to perform wireless communication using at least one radio access technology: and
one or more processors coupled to the at least one radio, wherein the one or more processors are configured to cause the BS to:
transmit, to a user equipment (UE) device, a quality of user experience (QoE) measurement configuration for a service to be received by the UE device in an idle state or an inactive state; and
receive, from the UE device, a QoE measurement report for the service.

20. The BS according to claim 19, wherein the service is a multicast and broadcast service (MBS), and wherein the one or more processors are configured to cause the BS to transmit the QoE measurement configuration by broadcast via one of the following:
providing the QoE measurement configuration in a system information block (SIB) related to the MBS;
providing the QoE measurement configuration together with an MBS session configuration related to the MBS; or
providing the QoE measurement configuration in a SIB dedicated to the QoE measurement configuration related to the MBS.

21-28. (canceled)
